(19) United States
(12) Patent Application Publication
(10) Pub. No.: US 2004/0082284 A1
(43) Pub. Date: Apr. 29, 2004

(54) Machine tool with bar kinematics

(76) Inventors: Heinrich Lutz, Dirlewang (DE); Hinrich Stave, Mindelheim (DE)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/347,416

(22) Filed: Jan. 21, 2003

(30) Foreign Application Priority Data
Jan. 21, 2002 (DE) 102 02 231.3

(51) Int. Cl. B24B 23/00; B23C 1/00; B23C 1/12

(52) U.S. Cl. 451/353; 409/235; 409/201

(57) ABSTRACT

The invention deals with a machine tool with a tool spindle holding device which is connected over at least one rod with a slide stand. The slide stand can move on a guide. The positioning of the tool spindle holding device is accompanied by the positioning of the slide stand. The tool spindle holding device carries at least two tool spindles.

### BACKGROUND OF THE INVENTION

The invention concerns a tool machine with a tool spindle holding device which is connected with at least one rod with a slide stand. Machine tools mentioned above are also described as machine tools with rod kinematics. In the technique they are also described as hexapods or machine tools with parallel kinematics.

Machine tools with Cartesian guides of the axis have to be distinguished from these machine tools. It is disadvantageous for these machines that a sequential construction is necessary in order to reach an orientation in the three space axes. This leads to comparatively large, heavy arrangements of the axes and therefore to limited speeds for positioning because of the large masses which have to be moved.

Parallel kinematics as mentioned above avoid this disadvantage, even though they are limited in their productivity, respectively efficiency.

### BRIEF SUMMARY OF THE INVENTION

The object of the invention is to provide a machine tool which is as productive as possible.

In order to achieve this object the invention starts with a machine tool as described above and proposes that the tool spindle holding device carries at least two tool spindles.

The tool spindle holding device is connected with the slide stand via the rod and the movement, respectively the positioning, of the slide stand in its guide leads to a corresponding positioning of the tool spindle holding device and thus also of the tool spindle. If, instead of only one tool spindle, several tool spindles are arranged, the productivity is increased, in particular with essentially symmetric machining, but also with respectively separated machining. The effort for the positioning of a tool spindle is considerably reduced because the corresponding guides and also the slide stand can be used simultaneously for several tool spindles.

The weight of the tool spindles is transferred evenly to the rods and their stands. The result is that the supporting members have to be dimensioned equally and in particular all members receive the same strain. No additional masses have to be moved simultaneously or accelerated because the respective axes are not arranged one above the other as in machine tools with Cartesian arrangement of axes.

The invention has the advantages that the moved masses in X-direction are considerably reduced and thus in this connection the expenses on the stand or the drive of the X-axis are saved. But not only the construction becomes more economical the machine uses less energy because smaller masses have to be moved.

The idea according to the invention aims at an even strain of all rods, respectively articulated arms. In contrast to the known articulated arm systems, which put a different strain on the articulated arms, respectively rods, therefore a source of inaccuracies which occur in known systems is avoided. It is possible to measure the way in each axis directly over a glass measuring stick.

The machine can be constructed a little bit lower and function in the same way thus making handling easier.

The preferred embodiment of the invention provides a joint between the rod and the tool spindle holding device, and a flexible connection of the rod with the tool spindle holding device. Thus the tool spindle holding device becomes sufficiently movable with reference to the rod, as it is necessary for a suitable positioning in the space. In the same way it is advantageous if a joint is provided between the rod and the slide stand.

In another variant according to the invention a joint is provided between the guide and the stand of the machine tool. In this case for example the flexible connection of the slide stand to the rod is done without, and the corresponding movement is reached by means of a joint arranged between guide and stand. It is advantageous if the rod has a corresponding slide stand, and the whole rod is suited to slide on the rod and not only the slide stand. Such variants may be advantageous, in particular when the space is limited, where for example on the side of the tool spindles is little space, but the concept according to the invention should be used nevertheless. In this case the tool spindle holding device is suspended from the rods in the stand, that means that the bearing point, respectively the joint on the stand, is positioned above the tool spindle.

In another variant of the invention it is provided that the rod is designed like a connecting rod, respectively a slab. In the figures the design as rod will be shown as well as the design as connecting rod. In contrast to the rod the connecting rod is torsion-proof. It is an advantage if, for example, the width of the slab, respectively the connecting rod, is adapted to the length of the tool spindle, respectively the headstock, in order to form a firm support for it. It is possible that the connecting rod is designed like a frame thus reducing the mass of the connecting rod. In a preferred variant of the invention the rod, respectively the connecting rod, is made of fiber reinforced, in particular carbon fiber reinforced synthetic material. The materials mentioned above are characterised by the fact that they do not change their length at all or hardly if the temperature varies. This makes the machine altogether more accurate because the temperature gradient of the previously known stands does not exist anymore. Two or more rods, respectively connecting rods, are provided to support the tool spindle holding device on one guide each. The connecting rods, respectively rods, have at their bottom ends a slide stand which moves on the guides. It is provided here that for example two rods, respectively connecting rods, are guided parallel and are guided by means of a common slide stand or a single slide stand each on a common guide. In such an embodiment the tip resistance increases, simultaneously comparatively large tool spindle holding devices can be held and guided safely in such embodiments.

In an alternative according to the invention a variable length of the rod, respectively the connecting rod, is proposed. The variation of the length of the rod makes it possible to reach in the same way a corresponding change of the position of the tool spindle holding device in the space. For example it is provided here to reduce the effective length of the rod, respectively connecting rod, wherein, for example, the rod or the connecting rod have the a guide way and glide like a slide on a stationary guide part. By means of that the effective length of the rod, respectively the connecting rod, is changed without reducing the stability which otherwise would occur, for example in a telescope-like design.

In a further embodiment according to the invention it is suggested that at least one slide stand on at least one guide of the machine tool is provided and each slide stand holds at least one rod or connecting rod flexibly. For example it is provided to suspend the tool spindle holding device on two, for example parallel guided, connecting rods or rods. For a further positioning in the space another rod or another connecting rod is sufficient which, on the one hand, is connected flexibly to the tool spindle holding device (if possible also to the other connecting rods) and, on the other hand, is connected flexibly to the slide stand, and the slide stand can move on a guide. Eventually for example a concept is proposed as it is shown in the FIG. 4b in a drawing.

In another variant of the invention it is provided that the tool spindle holding device is supported per guide over two rods, respectively connecting rods, and each rod, respectively connecting rod, is carried each over its own slide stand on the guide. Preferably the rods, respectively connecting rods, are guided parallel. They also have the same length in order to form a parallelogram. An example of this machine is shown, for example, in FIG. 3. As, in contrast to another variant of the invention, each rod, respectively each connecting rod, has its own slide stand it is possible to move them in a different way relatively to each other in order to carry out appropriate corrections of measurement or clearance.

The invention is free in the number of guides which are provided for the machine tool according to the invention. Optionally the machine tool can have two, three or four guides, and the tool spindle holding device is arranged between the guides. By means of a larger number of guides the stability of the machine is increased correspondingly.

Advantageous geometric relations result when the variant according to the invention suggests that the tool spindle holding device is supported on the guide via two rods, respectively connecting rods, which are in particular parallelogram-shaped. Through the parallelogram-like guide the horizontal orientation of the tool spindle holding device remains in place. Tipping is avoided.

A simple embodiment of the invention is characterised by the fact that the tool spindle holding device is supported via three connecting rods, respectively rods, on two guides. Such a variant is shown for example in FIG. 4b.

Basically it is possible to realise through this a space saving machine tool with the mentioned advantages.

In another variant according to the invention it is provided that the rods, respectively the connecting rods, cross. Such an embodiment also serves for saving space at the machine tool.

Furthermore it is provided that a first connecting rod, respectively a first rod, is supported in particular flexibly by a second connecting rod, respectively a second rod. The stability of such a variant according to the invention is improved. Especially if the tool spindle holding device is arranged above the guide way and the rods below the tool spindle holding device such a design allows a higher stability. Such a variant is shown, for example, in FIG. 11.

In another variant of the invention it is provided that the connecting rod, respectively the rod, is supported on the tool spindle holding device in such a way that it can slide. The stand for supporting the tool spindle holding device on the guide is turned around here and set in directly at the tool spindle holding device. Here, for example, a slide-like moveable guide stand is provided which can drive on a guide arranged below the tool spindle holding device. Such a design is advantageous for example with rods designed like shears as they are shown for example in FIG. 12.

Another variant of the invention provides that the rod, respectively the connecting rod, is divided by means of a knuckle joint into two sections. The invention is very versatile. New possibilities occur through the division of the rod by means of a knuckle joint into two sections. The whole arrangement is constructed on a slide stand which can move along a guide. The knuckle joints, which are, in particular, designed in a symmetric way, allow a movement of the tool spindle holding device in vertical direction in such a design.

If necessary a rotation drive is provided in order to achieve a synchronous rotation of the respective joints and thus to avoid tipping. Alternatively to that it is provided that a traction, respectively, a regulation mechanism acts on the knuckle joint, preferably on both knuckle joints simultaneously.

In another variant according to the invention it is suggested that the joints of both rods or connecting rods are arranged in the direction of the guide one behind the other, in particular on a line parallel to the guide on the tool spindle holding device. By means of such a design the geometric conditions become simpler. It is easily possible, in particular if identical lengths of the used rods, respectively connecting rods, are taken into consideration, to realise parallelograms which serve for movements of the tool spindle holding device which can suitably well be mastered.

As an alternative to that it is possible that the joints on the headstock of both rods, respectively connecting rods, which are supported by a common guide are arranged on a line which cuts the guide in an acute angle. An example of this kind is shown in FIG. 5.

The different variant allows optimising the invention for different conditions. On the one hand it is possible to realise a comparatively narrow machine which nevertheless has sufficient opportunity of movement of the tool spindle holding device.

In another variant according to the invention it is proposed that at least on one of the joints of the headstock at least two connecting rods, respectively rods, are connected. Such a design is shown, for example, in FIG. 6. By means of that another joint can be left out and sufficient movement is reached, nevertheless.

The arrangement is improved furthermore if, in another variant of the invention, the two connecting rods, respectively rods, are connected rigid angled to a common joint of the tool spindle holding device. The two connecting rods form a triangle increasing the torsional rigidity around the axis parallel to the rotation joint.

Preferably it is proposed that the distance of the joints between two connecting rods, respectively rods, on the tool spindle holding device is the same as the distance of the joints on the respective slide stand. That makes it possible to form a parallelogram-like guide or a shear-joint-like guide.

Alternatively to that it is provided that the distance of the joints between connecting rods, respectively rods, on the tool spindle holding device is not the same as the distance of the joints on the respective slide stand. For example a trapezoid-like design is formed which has also advantages in corresponding applications.

In another variant according to the invention it is provided that the rotational axes of the n joints on the tool spindle holding device result in an equilateral n-polygon. Such a design leads to a very high rigidity of the arrangement and a constant strain.

In another preferred embodiment of the invention it is proposed that for the slide stand on the guide a drive, in particular a spindle drive, ball roller spindle drive or a linear drive is provided.

Naturally the drives can be controlled accordingly accurately concerning the position so that the desired position of the tool spindle in the space can be reached. The application of linear drives, respectively of ball roller spindle drives, has proved itself sufficiently. The application of a linear drive additionally includes the possibility to realise a highly dynamic machine, that is a machine which approaches in a short period of time the respective position for machining.

The invention is not limited at all concerning the orientation of the spindle axis with reference to the guide. According to the invention it is provided that the guide is orientated essentially parallel or rectangular to the spindle axis.

In FIGS. 1a, b for example a variant is shown where the guide is orientated vertically and the guide in this example is orientated parallel to the axis of the spindle. In a special case also special angles may be included. For that another degree of freedom exists. In FIG. 9b for example the guide is orientated vertically, the spindle axis is, in this case, orientated rectangular horizontally to the guide.

The invention is characterised by a high flexibility of use.

In another variant of the invention an L-shaped slide stand is provided. The joints here are connected with the respective ends of the limbs of the slide stand and thus are on a line not parallel to the guide way. It is possible here to arrange only one joint on an L-shaped slide stand the joint being arranged on the limb distant from the guide.

According to a further development of the invention it is proposed that each slide stand has its own guide, or one guide guides several or all slide stands. It is, for example, possible in the variant according to the invention to arrange only one guide on which all slide stands are guided. Such a variant is shown, for example, in FIG. 11.

In addition to that it is provided in one variant of the invention that the guide itself has a slide-like design and can be positioned on a guide way. By means of that it is possible to shift and to position the whole arrangement.

The rods are connected with the tool spindle holding device via joints. The former is, according to the invention, designed for example as headstock and carries, for example, sleeve and tool spindle. In another variant the tool spindle holding device holds a headstock, that means that it carries it and that it has also other elements. The headstock itself holds the tool spindle. In a third variant it is possible that the tool spindles are suspended on the tool spindle holding device or are carried by it.

It is an advantage if the tool spindle holding device, respectively the headstock, is made of aluminium. On the one hand this design made of aluminium saves weight and, on the other hand, aluminium is not magnetizable which is a particular advantage for the use of linear drives in order to avoid that iron chips and the like adhere on the tool spindle holding device.

In another variant of the invention it is provided that the tool spindle, respectively the headstock, can be twisted with reference to the tool spindle holding device and/or the tool spindle can be moved and also positioned on the tool spindle holding device in the direction of the spindle axis as well as rectangular to it. These variants according to the invention present several opportunities. On the one hand the twisting provides an additional rotational axis for the positioning of the tool spindle. Also a shifting of the spindle in the direction of the axis, as it is for example carried out by a sleeve, makes it possible that certain spindles do not come into operation if a plurality of spindles is arranged. In addition to that, however, the invention proposes that appropriate controlling means are provided in order to correct the position of the spindle on the tool spindle holding device. Thus corresponding dimensional tolerances, wherever they may occur, can be adjusted. This is achieved, for example by means of corresponding actuators, for example piezo actuators or the like.

Furthermore it is provided that a tool magazine is arranged in the region of the tool spindle, respectively above the tool spindle. The use of a tool magazine for changing the tools of the tool spindle is common. The arrangement of the tool magazine is carried out in such a way that the working area does not narrow. It is possible here to construct the tool magazine in such a way that it can be lowered in order to bring the spindle into a changing position in case the room for movement for the arrangement is not sufficient. Preferably one magazine each, if possible a disc magazine or chain magazine, is provided for each tool spindle.

The invention suggests furthermore that in particular on the tool spindle holding device and/or the slide stand a counterweight is provided which may be carried flexibly. The use of a counterweight is also known in the field of machine tools. Advantageous is in particular the use of a counterweight directly at the tool spindle holding device a flexible support being an advantage here. Thus the tool spindle holding device always has a weight balance independently from its position in the room.

Additional features according to the invention follow from the description of the drawings, respectively the drawings. Independent from its illustration the following features will be claimed in different combinations and thus have to be looked at as each being independently important for the invention.

### BRIEF DESCRIPTION OF THE DIFFERENT FIGURES AND DRAWINGS

In the drawing the invention is shown diagrammatic. In the figures:

FIGS. 1a, 1b a three dimensional view of the machine tool according to the invention

FIG. 1c a detail of the invention according to FIGS. 1a, b (see arrow I c)

FIGS. 2, 3, 4a, 4b, 5 to 8, 9a, 9b, 10 to 14 a view of further variants each of the machine tool according to the invention

### DETAILED DESCRIPTION OF THE PREFERRED EMBODIMENTS

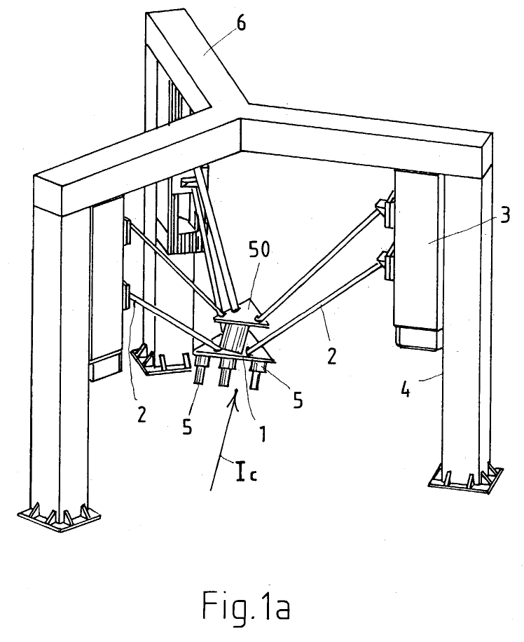

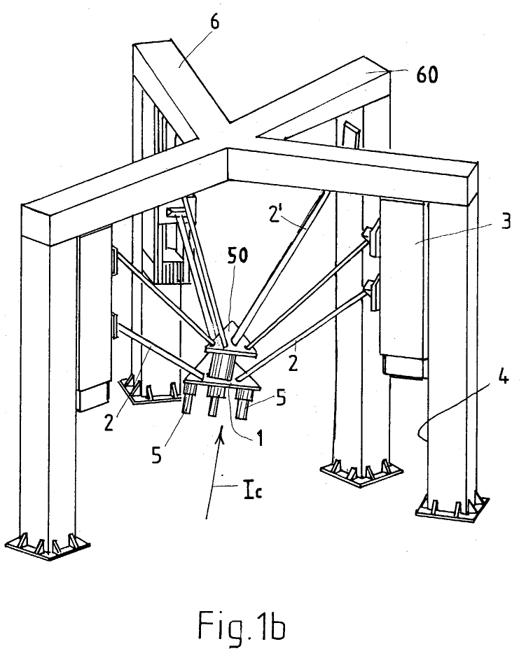

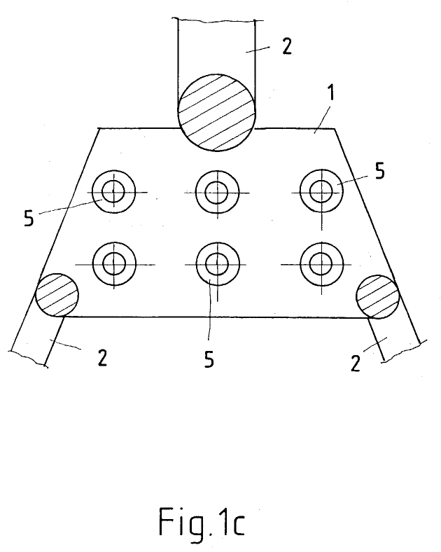

In FIG. 1a, respectively FIG. 1b, a machine tool is shown which comprises six (FIG. 1a), respectively seven rods 2, 2′ (FIG. 1b). The rods 2, 2′ may have constant or variable length. The rods 2 hold a tool spindle holding device 1, respectively connect the tool spindle holding device 1, with the slide stands 3 the slide stands 3 being movable along the guide 4 of the stand 6.

The additional rod 2′ shown in FIG. 1b is supported by a fourth additional stand rest 60. The rod 2′ here has the same design as the rods 2, that means it is supported movably. The rod 2′, in contrast to the other rods 2 (which are each used double), is only realised as a single. It serves for increasing the stability of the positioning.

It is clear that by means of this arrangement not only a high movability of the spindles 5 in the space is reached but also a tipping of the tool spindle holding device 1 in the space is possible. Thus also machining angles which differ from the vertical line can be reached.

In FIG. 1c a view from the bottom of the tool spindle holding device is shown. A plurality of tool spindles 5 is provided. Their axes are orientated parallel and project downward. If necessary, the rods 2 are connected by a joint not shown here with the tool spindle holding device 1.

The example shown here and in FIG. 1a of the tool spindle holding device can be described for example as follows. The tool spindle holding device 1 is designed like a stand with a bottom and a top slab. The top slab 50 defines the back end with reference to the tool spindle 5. The rods 2 are connected to the respective slabs. It is an advantage here to select the connecting point of the rods arranged in pairs (with reference to the respective slide stands 3) in such a way that the arrangement becomes as stable as possible. This is achieved if the rods are flexibly connected, if possible, to the front and back end of the tool spindle holding device.

The embodiment with a constant length of the rods 2 is shown, the machine may as well be designed with rods of a variable length. The spindles 5 can, as indicated here, be orientated vertically or arranged horizontally. The advantage of such machines is a high dynamic of the axis because the respective masses which have to move are very low. Furthermore the machine has the advantage that, if the spindles 5 are arranged only in one plane, the degree of freedom of the rotation (corresponds with the tool spindle holding device 1) of the platform can be used for the machining. The degree of freedom of the rotation which can be used is here parallel to an imaginary axis which is rectangular to the spindle axes and cuts all spindle axes.

In the following the tool spindle holding device 1 will be described also as platform or headstock without preferring a particular embodiment.

The machine tool shown in FIG. 1 has either six or seven rods 2, 2′. A fourth stand rest of the stand 6 is indicated with 60. This additional rod 2′ serves for stabilising the tool spindle holding device 1, respectively for torsion rigidity. In another preferred embodiment of the invention it is provided that on the tool spindle holding device 1 at least one machining spindle 5 can be shifted relatively to the platform 1 along its longitudinal axis.

Here the advantage results that up to three rotational degrees of freedom of the platform can be used for machining by means of a suitable selection and arrangement of the spindles which can be shifted longitudinally. Furthermore it is achieved that, if all spindles or all but one are designed that they can shift longitudinally, the machine can also machine with one spindle or with all spindles one after the other. In this case the option that the machine can machine simultaneously with several spindles is left out deliberately. This has advantages for example with very small machining tolerances or the failure of one or more spindle/s. Furthermore such an arrangement has the advantage that simultaneously several tools with different active length may be used.

It has to be taken into consideration that the rods 2, 2′ are connected flexibly with reference to the slide stand 3 as well as to the tool spindle holding device 1 resulting in a corresponding movement in the space and in several, in particular three, rotational degrees of freedom.

In addition to that it is possible that the platform 1 is supported in such a way that it can rotate, forming a “rotational holding device”.

In a preferred embodiment of the invention it is provided that a tool spindle 5 is supported not only to be shifted longitudinally but also, relatively to the platform, to be shifted or turned transversely to its longitudinal axis. This is made possible, for example, by means of piezo actuators. It is an advantage of such a machine that all geometric errors of the machine and the device are balanced.

Usually no particular concept for the use according to the invention is provided for the guide of the slide stand 3 on the guide 4. On the other hand it is possible that any guide system can be used for the application in the invention, in particular spindle drives, ball roller spindle drives, linear drives or the like.

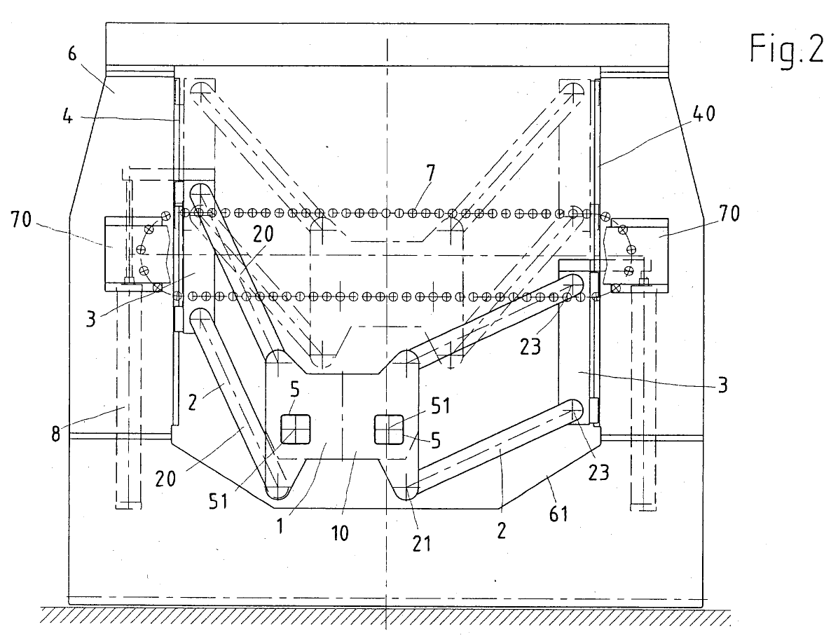

FIG. 2 also shows a machine tool according to the invention. A machine with at least two main spindles 5 is shown which are guided in a sleeve which forms the Z-axis. The Z-axis therefore describes the shifting possibility in longitudinal direction relatively to the tool spindle holding device 1, respectively the platform 1.

The rotational axis of the tool spindle 5 is indicated with 51.

It is an advantage that the tool spindle axes 51 of the at least two tool spindles 5 are on a horizontal plane. For that it is in particular preferable if a suitable balance control or device is provided. Advantageously it is achieved through that that in a corresponding horizontal arrangement of two workpieces with the two tool spindles 5 a machining each on two different workpieces can be carried out simultaneously. The technical advantage for the production is obvious.

In a preferred embodiment of the invention it is provided that the rod 2, 2′ has a connecting rod-like shape 20. In contrast to a rod which takes up compression-tension forces the connecting rod is torsion-proof.

It is provided here that the connecting rod 20 is designed in particular like a slab and thus is torsion-proof. In the same way as the rod 2, 2′ also the connecting rod 20 is connected via the joint 21 flexibly with the tool spindle holding device, respectively the platform 1 or the headstock 10, and via the joint 23 flexibly with the slide stand 3.

Here also two rods 2 or connecting rods arranged parallelogram-like are arranged parallel each to one another in order to reach a corresponding stability and movement.

In FIG. 2 two positions of the tool spindle holding device 1 in the space are indicated. The first bottom position is drawn with a continues line, the position with a broken line is indicated above it. It can be seen clearly that another position of the slide stand 3 leads to another position of the spindle holding device 1 and thus of the tool spindles 5 in the space.

In the example in FIG. 2 it is provided that the direction of motion of the slide stands 3 on the guide 4 is vertical. That means that the guides 4 extend vertically resulting in several advantages. It is possible, by means of that, to arrange the whole drive and guide mechanism relatively high above and outside of the range of chips. Thus it is avoided that in a chip removing machining occurring chips reach the range of the joints 21, 23 and so on and there maybe disturb the movement of the rod 2. Nevertheless the embodiment according to the invention reaches a position of the tool spindle holding device 1 in a plane (here the plane of the sheet) the design of the machine tool being selected in such a way that the engine bed 61 is formed as a trough in order to collect the dripping coolant and to recycle it back into the cycle. This avoids the forming of pockets and so on where coolant or chips could accumulate.

The use of a sleeve allows the realisation of a chip protection cover which separates the workroom completely from the machine room.

In another preferred embodiment of the invention a tool magazine 7 is provided in the machine tool. This tool magazine 7 is held with two fixing devices 70 and holds a plurality of machining tools for the tool spindles 5. Here the tool magazine 7 is arranged above the tool spindle holding device 1 (in its usual working position). If necessary the tool spindle 5 has to be positioned at the tool magazine 7, and an appropriate changing device changes the machining tools. The tool magazine is here a continuously circulating chain with corresponding holding devices for the tools and has, if necessary, a drive which allows a suitable positioning of the tool magazine. However, there are also other magazine concepts, for example circular disc magazines and the like, which carry out the same.

Furthermore it is an advantage that a counterweight 8 is provided. This counterweight 8 which works in particular according to the principle of a deviated weight or with a tension or force means, for example a hydraulic working cylinder or the like, allows a reduction of the weight which has to be moved and thus reaches high accelerations of the slide stands 3 on the guide 4 with lower driving forces. For that purpose the counterweight 8 is connected in suitable way, for example by means of an appropriate support with the slide stand 3.

The variant according to the invention shown in FIG. 2 results in a very rigid configuration. On each side of the headstock 10 two connecting rods are arranged on above the other and each of the stands 40 of the guide 4 carries each a slide 3 by means of which two connecting rods each are supported. The top connecting rod is connected to the headstock 10 above the spindle 5, the bottom connecting rod below the spindle 5. It can be discerned that the axis 51 of the spindle extends rectangular to the guide 4. Nevertheless a stable support is reached namely by arranging the spindle 5 between the two connecting rods 2, 20.

In this case the connecting rods 20 are arranged in pairs with the same length and parallelogram-like.

For simplifying and mass saving purposes a connecting rod 20 can be left out on one side of the tool spindle holding device. Preferably the bottom connecting rod is left out because therefore space is saved in the region of the workpiece.

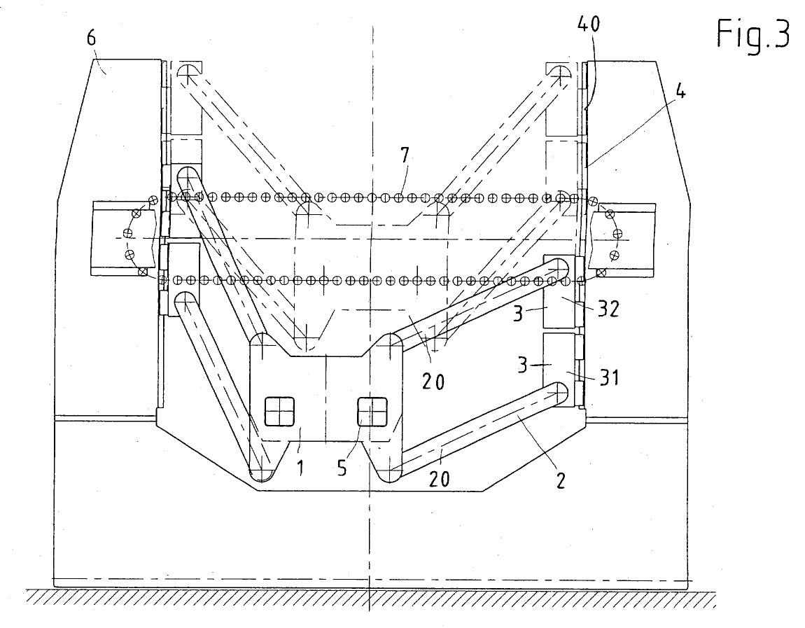

The suggestion of a machine tool of the invention according to FIG. 3 differs only in a few points from the suggestion according to FIG. 2. According to the suggestion in FIG. 3 not two connecting rods 20 are supported by a common slide 3, but each connecting rod 20 is assigned its own slide 3 which is indicated in FIG. 3 with the slide 31 for the bottom connecting rod 20 and with the slide 32 for the top connecting rod 20. For simplification purposes the second slide 31 and the second connecting rod 2 can be left out on the second side. The following advantages follow from that.

For the movement in the XY-plane (this is, in this case, the plane of the sheet, the Z-axis is the direction of movement in the sleeve/working spindle) at least three drives are necessary.

Production errors in the length of the connecting rods, respectively in the bearing coordinates, can be compensated by means of correction movements of the drives.

The headstock 1 may be rotated around the Z-axis therefore alignment errors of the machine tool, respectively the device (which holds the workpiece) can be corrected, the demands for the exact manufacturing of the machine components decrease.

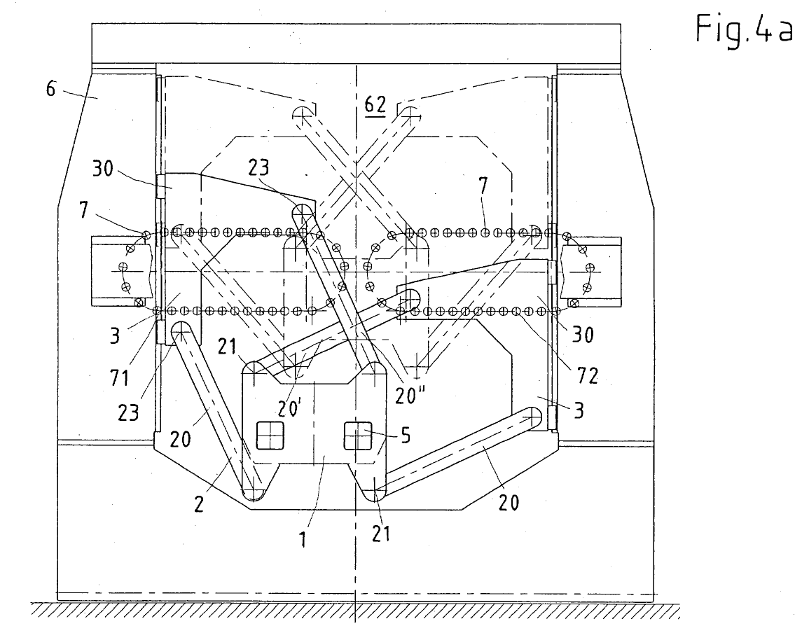

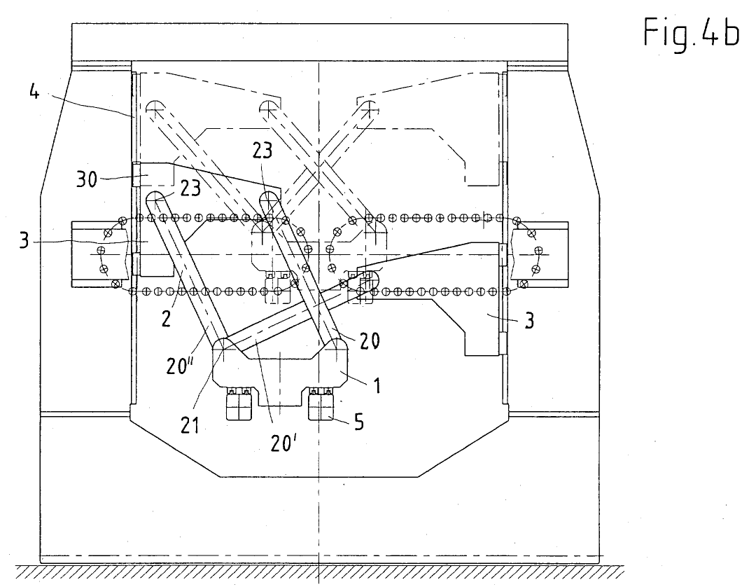

In FIG. 4a another variant of the machine tool according to the invention is shown. In FIG. 2 the joint points 23, where the connecting rods 20 were connected flexibly with the slide stands 3, were arranged vertically one above the other, in particular their connection line parallel to the guide way 4, now this geometric connection in the solution according to FIG. 4a is abolished. The slide stand 3 has an L-shape 30 the upper joint point 23 being orientated in this example away from the guide 4 into the machine room 62.

The rods, respectively connecting rods 20, connected to the slide stand 3 (which is in one piece) again have the same length, the arrangement of the connecting rods to each other is again parallel. However, it is indeed possible to provide connecting rods, respectively rods, with different length. In this case it is an advantage if separate, independent foot slides are provided for the connecting rods with different length.

The embodiment shown in FIG. 4a allows a space saving arrangement because the distance of the two stands 40 which form the guides 4 can be chosen smaller. The connection line of the respective joints 23 of the connecting rods 20 connected with the slide stand 3 cut the guide ways in an acute angle.

Another measurement to reduce the space the machine tool needs is also shown in FIG. 4a. The top connecting rods 20′ and 20″ which connect the tool spindle holding device 1 with the left hand respectively the right hand slide stand 3 cut each other. This is reached by means of a corresponding mutual recess of the slab-like connecting rods 20 or with a corresponding spacial displacement. This crossing of the connecting rods 20′, respectively 20″, does not inevitably have to be accompanied by the L-shaped 30 embodiment of the slide stand 3, this may be also realised with correspondingly longer connecting rods 20′, 20″. In this variant according to the invention it is an advantage that the longer connecting rods end on independent slides stands. The different slide stands can also be moved in a different way.

The variant according to FIG. 4a shows also an alternative with reference to the arrangement of the tool magazine 7. Instead of a common chain magazine 7 for all spindles, as it is shown in FIG. 2, respectively 3, in FIG. 4a one chain magazine 71, 72 per spindle is provided. The first tool magazine 71 is provided here for the left hand spindle and the second tool magazine 72 for the right hand spindle 5.

The L-shaped slide stand 30 shown in FIG. 4a is designed in one piece. However, it is also possible to realise a corresponding horizontal displacement of the two connecting rod joints 23 with a two piece embodiment of the slide stand, similar to FIG. 3. From that follows a plurality of opportunities for arrangement and movement.

FIG. 4b also shows on the right hand side a slide stand 3 which has L-shape 30 and is designed in one piece. The left hand slide stand 3 has two joints 23 to which one connecting rod 20, respectively 20″, each is connected flexibly. The actually suspended arrangement of the tool spindle holding device 1 with the tool spindles 5 is preferred for stability reasons, because the tool holding device 1 is “suspended” via the two connecting rods 20, 20″ on the left hand, L-shaped slide stand 30. The joints 23 to which the connecting rods 20, 20″ are connected, are here on a line which extends essentially horizontally. The connection line of the two joints 23 is rectangular to the guide 4.

As already mentioned above the double arrangement of the connecting rods 20 can be left out on one side. At least three connecting rods 20 are necessary for a positioning of the tool spindle holding device 1 in the space. This is shown in FIG. 4b. The right hand slide stand 3 carries only one connecting rod 20′ which is connected to the left hand joint 21 of the headstock 1. Again a crossing point between the connecting rod 20′ which is connected to the right hand slide stand 3 and the projecting inward (right hand) connecting rod 20 of the left hand slide stand 3 results.

The right hand slide stand 3 is also designed as an L. The L-shape, however, is not compulsory here. If the limb projecting into the working room can be avoided or shortened it will be possible to build a smaller machine.

For the connection of the connecting rod 20′ (of the right hand slide stand 3) to the joint 21 of the tool spindle holding device 1 there are now two variants. In a first variant the angle between the connecting rods 20′ and 20″ is constant and the length of the connecting rod 20′ varies. In another variant the respective lengths are constant and the angle between the connecting rods 20′ and 20″ vary with a corresponding positioning. By means of the movement of the right hand slide stand 3 the headstock 1 (and the tool spindles 5 suspended on it) is turned around the joints 23 of the left hand slide stand 3. Because of the parallelogram-like connecting rods 20″, 20 the horizontal arrangement of the tool spindles 5 relatively to each other remains.

In opposition to the embodiment of the tool spindle holding device 1 shown in particular in FIG. 4a and the tool spindles 5 fastened, respectively embedded, to it in the variant according to FIG. 4b it is provided that the tool spindles 5 are arranged below the actual tool spindle holding device 1. They are not embedded in this variant.

The advantage of an arrangement of the spindles 5 below the actual headstock 1 (suspended) results in a particularly light headstock, that means that the masses to be moved are considerably reduced.

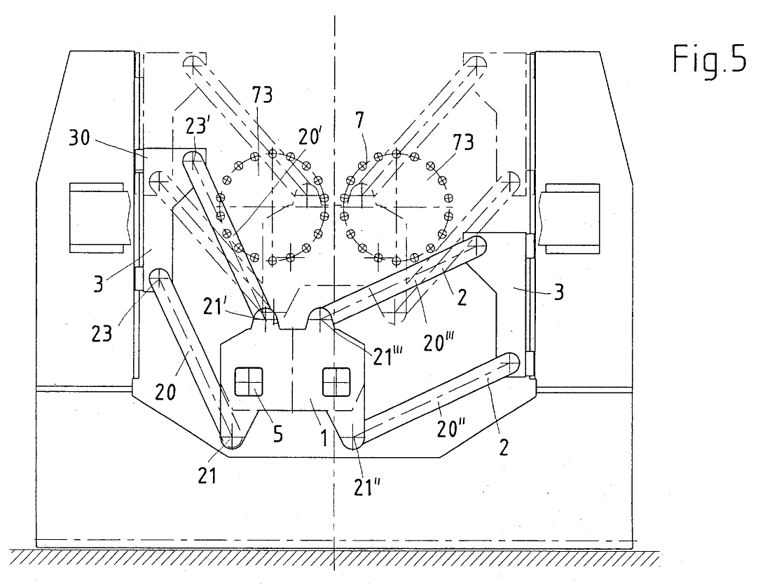

In FIG. 5 another variant of the machine tool according to the invention is shown. Similar to FIG. 4a this variant shows L-shaped 30 slide stands 3. However, these are not as strongly dimensioned as the ones in FIG. 4a, that means that the horizontal displacement of the joints 23, 23′ of the connecting rods 20, 20′ is less than in FIG. 4a.

In contrast to the suggestion in FIG. 4a FIG. 5 also shows a horizontal displacement of the position of the joints 21, 21″, respectively 21′ and 21′″ (at the joint 21), to which the connecting rod 20 (at the joint 21), the connecting rod 20′ (at the joint 21′), the connecting rod 20″ (at the joint 21″) and the connecting rod 20′″ (at the joint 21′′) of the tool spindle holding device 1 are connected flexibly. The connecting rods 20″ and 20′″ are arranged on the right hand side of the tool spindle holding device 1 and connect it with the right hand slide stand 3. Also such an arrangement may be used preferably for a correspondingly narrow design of a machine tool according to the invention.

The horizontal displacement of the position of the joints 21, 21′ cooperates here with the horizontal displacement of the joint points 23, 23′ on the slide 3. If the rods 2, respectively the connecting rods 20, and so on, have the same length the result is a parallelogram-like design.

In the variant according to the invention shown in FIG. 5 disc magazine 73 is provided as tool magazine 7. Here for each spindle 5 an independent disc magazine 73 is provided.

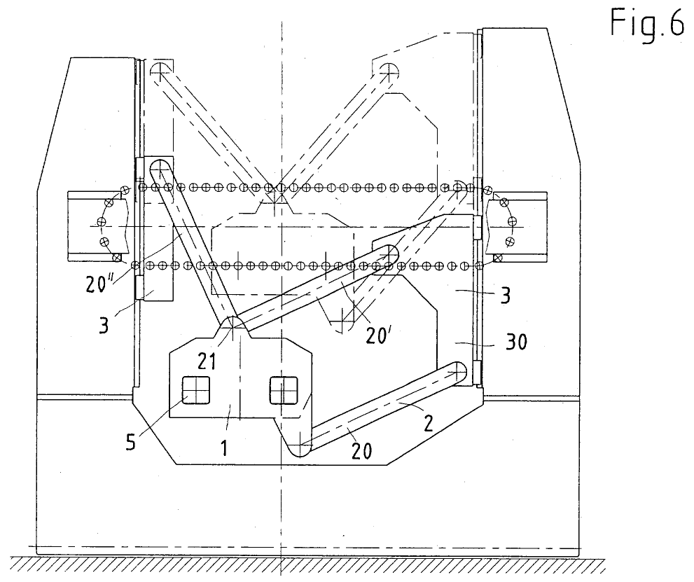

In FIG. 6 another variant according to the invention is shown. Similar to FIG. 4b two connecting rods 20′ and 20″ engage at the headstock 1 at the same bearing axis 21 of the headstock 1.

Thus the position of this axis is defined clearly by the position of the base points of this connecting rod. For stabilising at least a third connecting rod 20 (for example on the right hand side) is necessary in order to define the orientation of the headstock 1 around the Z-axis (rectangular to the plane of the sheet). This connecting rod 20 can optionally receive its own slide making the orientation of the headstock controllable, or it can be supported together with another connecting rod 20′ on a common slide and/or form a parallelogram together with that, as it is shown. Optionally this slide stand 3 may have L-shape or be designed in a straight line (see for example in FIG. 2).

The embodiment of invention described above and in FIG. 6 has the following advantages. The machine becomes smaller. The mass of the headstock 1 can be reduced because less points for receiving joints have to be provided. The kinematics will be easier to determine because the arrangement can be driven by means of simpler movement equations. Furthermore a higher turning rigidity around the Z-axis results because the two connecting rods 20′ and 20″ form a triangle (with constant angles between the connecting rods), similar to the alternative arrangement already proposed above in FIG. 4b.

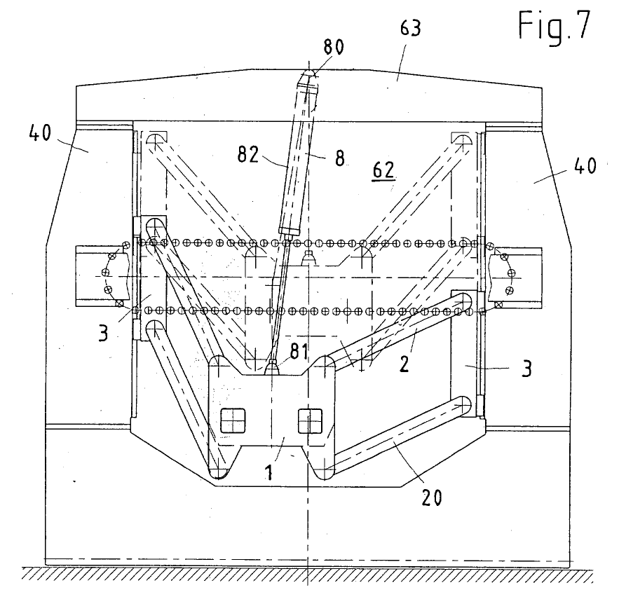

FIG. 7 is similar in its design to FIG. 2. In FIG. 2 in particular a counterweight 8 is provided the compensation force being arranged in the design according to FIG. 2 on the left hand and right hand side of the headstock and being in particular independently controlled from the difference of positions of the right hand and left hand slide stand 3.

Alternatively to that in FIG. 7 a central counterweight 82 is provided which is connected flexibly on a transverse bar 63 of the stand 6 with the joint 80. The transverse bar 63 connects here the stays 40 which stand essentially vertically and limits the height of working room 62. The counterweight 8 is here, for example, designed as a (hydraulic/pneumatic active) working cylinder and allows, because of the flexible support 80 on the traverse bar 63 also to carry out the different positions in the XY-plane of the tool spindle holding device 1. The central counterweight 82 is connected in the center at the upper end of the tool spindle holding device 1 also flexibly with the joint 81. The counterweight 8 takes over a part of the holding force (if necessary a large part) for the headstock 1; the whole weight does not rest any more on the slide stands 3. The arrangement of the counterweight above the headstock 1 has the advantage that soiling through chips and so on is preferably avoided.

The counterweight 8 according to FIG. 2 and the counterweight 8/82 according to FIG. 7 can naturally after a further development, if necessary, be combined with each other, that means that on the left hand side and on the right hand side as well as in the center a counterweight each is provided.

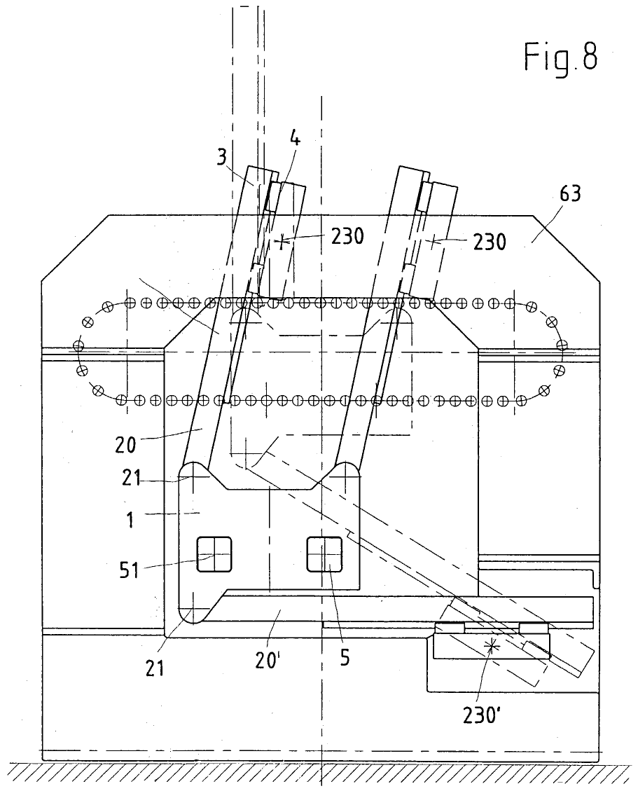

A variant according to the invention is also indicated in FIG. 8. In this concept, which here is also comprised in the invention, the rod 2 and the slide stand 3 form a unit. These two components are hybridised. The guide 4 is arranged above the knuckle joint 23 on the traverse bar 63 and is supported in such a way that it can be shifted. Again the position of the rod 2 above the slide stand 3 can be changed changing also the position, respectively the positioning, of the tool spindle holding device 1 in the space. If in the embodiment of FIG. 2 the guide way 4 was determined in the space, because of the design as a stand, now the guide way 4 is orientated turnable around the joint 23. Therefore it is possible to form the stand foot as upper end of the rod 2, respectively connecting rod 20, on it.

The concept shown in FIG. 8 corresponds eventually to a kinematics inversion of the concept shown in FIG. 2. Actually a longitudinal shift of the slide stand in its guide remains and that leads to a corresponding changing of the position of the headstock and thus the tool spindle 5. Additionally the active length of the rod 2, respectively the connecting rod 20, can be changed by this concept in an elegant way without reducing the stability, that is the rigidity and thus the mechanical loading capacity more than necessary for example by means of a corresponding telescope-like design.

In FIG. 8 the structural component mentioned above comprising connecting rod 20/rod 2, base point 3, guide 4 is used up in the construction three times. However, also mixed forms could be provided that is where, for example, the concept of FIG. 8 is realised once and the concept according to FIG. 2 is realised also once or twice and so on.

The connecting rod 20 is again connected flexibly via the joint 21 with the tool spindle holding device 1. The machine tool stand 6 has a traverse bar which is arranged at the top, where the joints 23 (in one plane) are arranged, where the respective guides 4 and so on are supported. The tool headstock 1 is again in the design according to FIG. 8 suspended on the connecting rods 2, 20. A connecting rod unit designed in the same way is provided on the right hand side of the headstock 1 this connecting rod unit 20′ being turned around the rotation point 23′ if the arrangement is to be positioned in the space. Again the embodiment shown in FIG. 8 forms a parallelogram between the two connecting rods 20 arranged above the headstock 1. The distance between the two joints 23 is here in essential the same as the distance of the respective joints 21 of the two connecting rods. Naturally a deviation from this geometric connection is possible in the sense of the invention.

The advantage of the variant shown in FIG. 8 is the very narrow shape of the machine tool according to the invention which is shown here. The rods necessary for the positioning of the tool spindle holding device 1 are arranged above the tool spindle holding device and not on the side, as, for example, in the embodiment according to FIG. 7. These elements which take up the load are carried more on the top and thus do not need room on the side. It is true that the third connecting rod is arranged on the right hand side laterally but even this could be provided for example below the tool spindle.

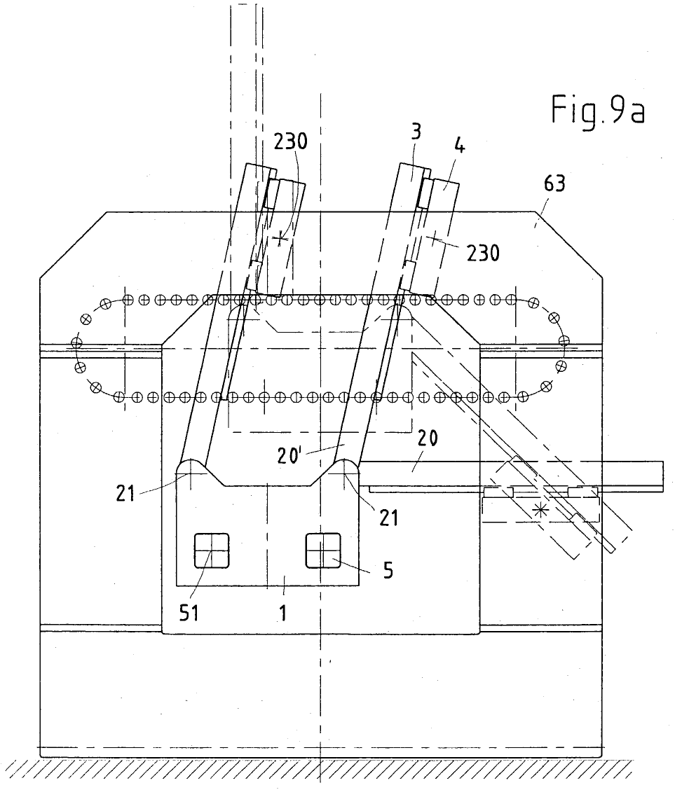

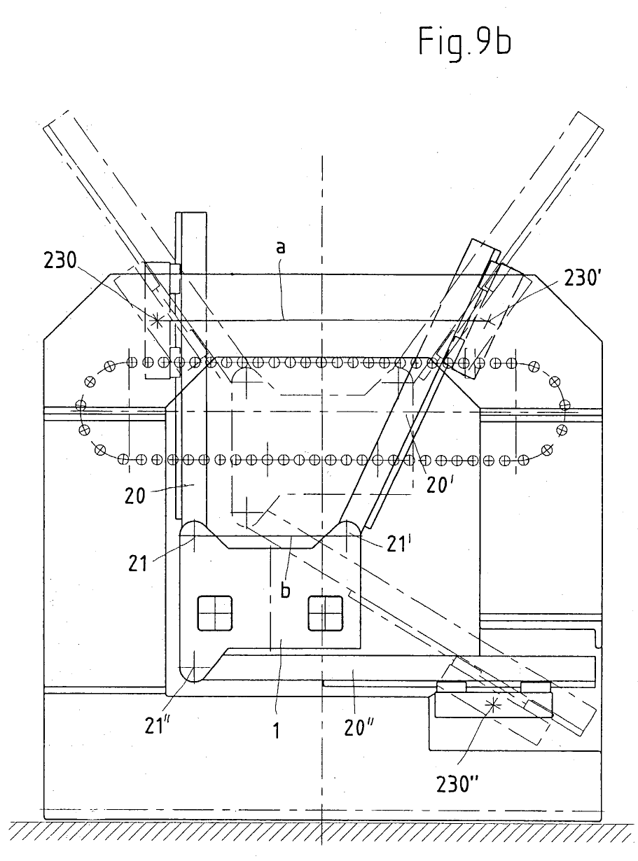

FIG. 9a illustrates a variant according to the invention concerning the suggestion according to FIG. 8. In FIG. 8 the connecting rod 20′ which guides the tool headstock 1 laterally is connected above the joint 21 below the tool spindle axis 51. This results in a comparatively deep arrangement of the connecting rod 20′ and the accompanying guide elements (joint 230′ and so on). In contrast to that the right hand connecting rod 20 in FIG. 9 is arranged above the spindle axis 51 and shares the joint 21 with the connecting rod 20′. However, the two connecting rods 20, 20′ are not connected at a constant angle with each other in this variant but can move against each other. This becomes clear, in particular, in the second position indicated by the broken line. This variant is more preferable with respect to an imminent soiling because of the chip removing machining. The advantage exists also here that in a simultaneous use of the joint 21 through the connecting rod 20, respectively connecting rod 20′, a four bar chain becomes a three bar chain which in itself is more torsion proof around the Z-axis.

The embodiment of the invention according to FIG. 9b comes from the suggestion according to FIG. 8. In the solution according to FIG. 8 the length of the distance of the centers of the turning joints 23 of the guides 4 arranged above the spindle was the same as the distance of the joints 21 corresponding with them to which the connecting rods 20 are connected with the tool headstock 1.

The suggestion according to FIG. 9b deviates from that.

In FIG. 9b the distance of the joints 230, 230′ of the two connecting rods 20, 20′ is indicated with a. This distance is clearly larger than the distance b between the two joints 21, 21′ through which the tool spindle holding device 1 is connected with the respective connecting rods 20, 20′.

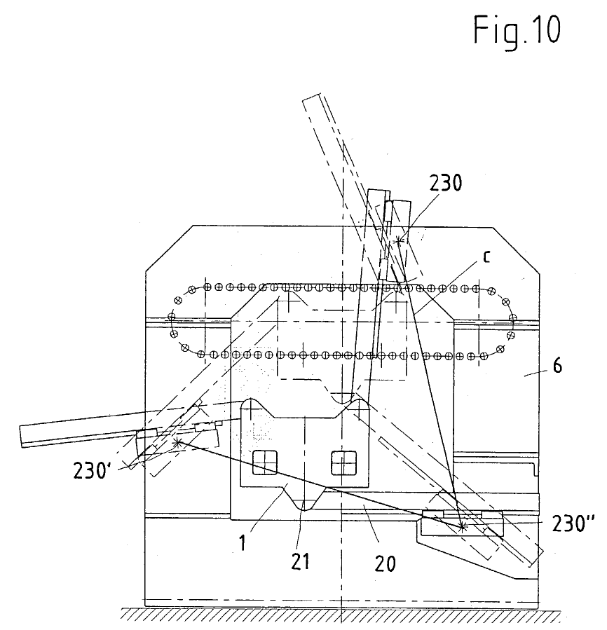

In FIG. 9b the respective joints 230, 230′ and 230″ form an irregular triangle (not isosceles, not equilateral or rectangular). The arrangement of the centers of the turning joints 230, 230′ and 230″ is more incidental. The suggestion according to FIG. 10 deviates from that. The arrangement of the joints 230, 230′ and 230″ at the stand 6 is selected in such a way that an equilateral triangle C results. The length of the sides is chosen as long as possible in order to reach rigidity as high as possible. The bottom connecting rod 20 is connected via the joint 21 with the tool spindle holding device 1 the leading point 21 with reference to the tool spindle holding device 1 being chosen in the center. In the variant according to FIG. 9b the engaging point of the bottom connecting rod 20″ is arranged via the joint 21″ in the left hand region of the spindle holding device 1.

If more than three connecting rods 20 are provided N joints 23 have to be arranged in such a way that a N polygon with a defined circle as large as possible results in order to reach a high rigidity. The advantage of such a design is the fact that the headstock 1 is then guided particularly rigid (in particular with reference to undesired rotations around the Z-axis).

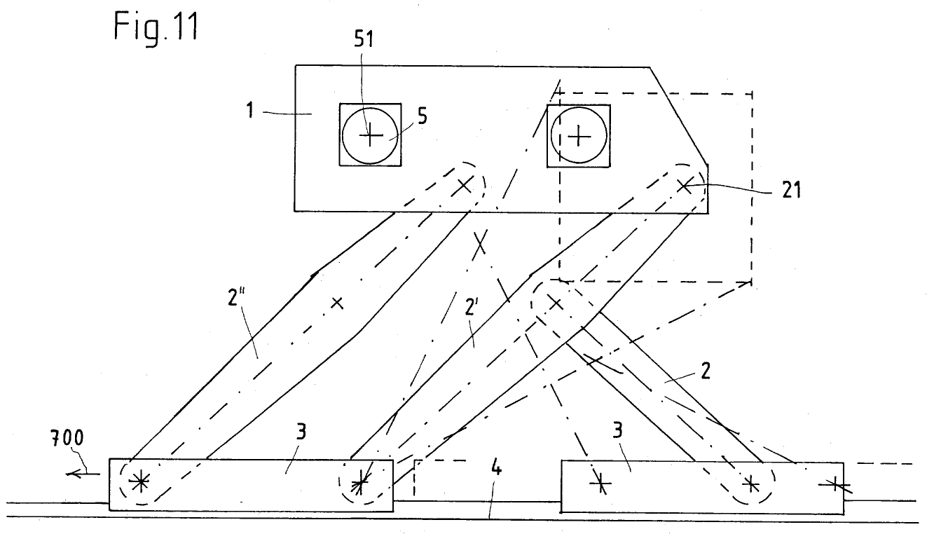

In FIG. 11 another variant according to the invention is shown. The slides 3 are supported by guide 4, which is essentially horizontally orientated or slant, in such a way that they can shift. In this example all slides 3 are provided on a guide 4. The left hand slide 3 carries over two connecting rods 21′ and 22′ the tool spindle holding device 1 with two tool spindle 5. The right hand one of these two connecting rods 2′ is supported by another rod 2 which itself can also be shifted on the same guide way over the slide stand 3. Also another guide way may be provided for this purpose, also a way which is otherwise slant or arranged. The rod 21 can alternatively also engage at the joint center 21. This saves another joint. The movement of the slide stand is indicated by means of the arrow 700.

The embodiment shown here calls to mind a lambda. The arrangement allows a high movement in space and leaves out a corresponding expensive design of a machine stand.

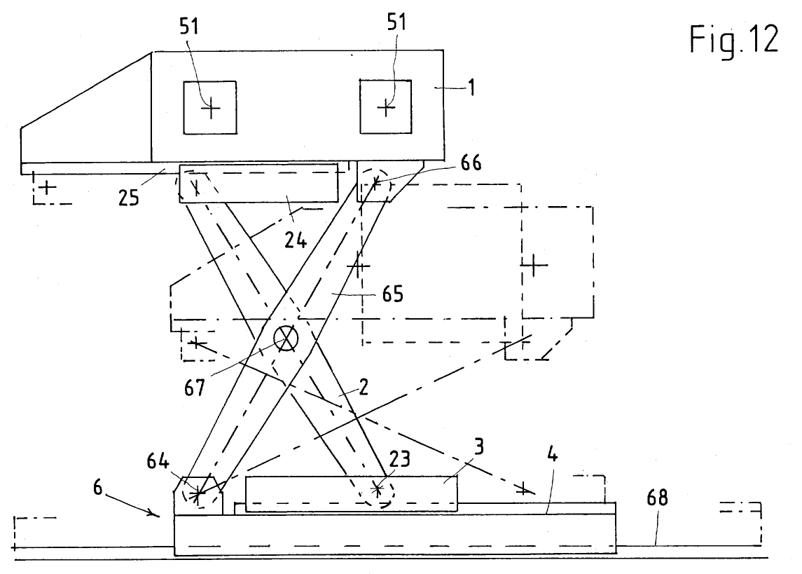

FIG. 12 shows another interesting variant of the invention. The tool spindle holding device 1 is supported via a connecting rod 65 over the joints 66 and 64 on the stand 6.

Simultaneously the tool spindle holding device 1 is supported via the rod 2 and the slide stand 3. The slide stand 3 moves, as already described, on the guide 4. Now the rod 2 is flexible, shear-like connected through the joint 67 with the rod. Simultaneously a guide foot which can be moved like a slide is arranged on the tool spindle holding device 1 the guide foot being movable on the guide 25 which is arranged below the headstock 1. Therefore also the guide foot 24 is displaced in the guide way 25 to the left hand side and the connecting rod 65 is lowered via the shear joint 67, if the slide stand 3 is moved correspondingly on its guide 4 in the same way (if the arrangement is symmetric). Therefore the whole tool spindle holding device 1 is lowered, respectively can be positioned in the space. In addition to that it is provided that the guide 4 itself has a slide-like design and is supported movably on the guide way 68. By means of that a flexible arrangement of the tool spindle holding device 1 on a surface is reached in two superpositioned translational movements, first of the slide 3 on the guide 4 and second of the guide 4 (itself as slide) on the guide 68. Alternatively this may be achieved if the joint is supported movably on its own slide stand on the same guide way as the slide stand 3.

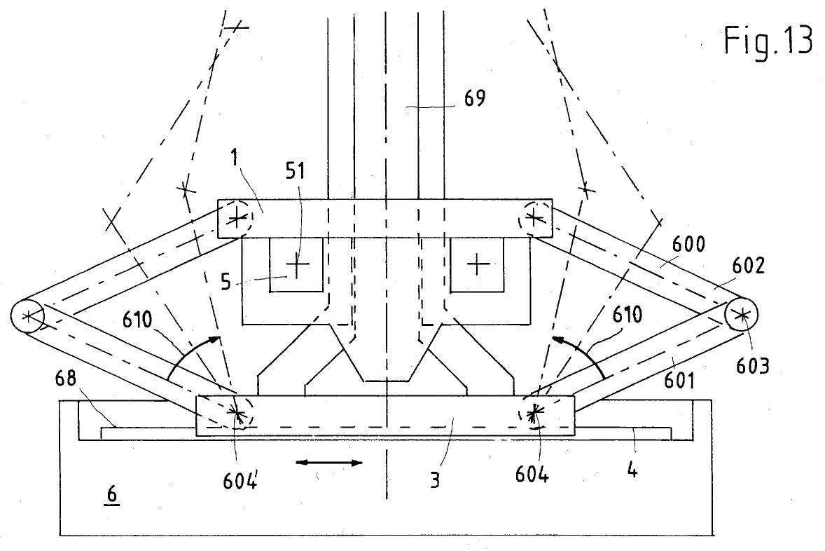

Another concept according to the invention is shown in FIG. 13. The tool spindle holding device 1 is supported movably on the guide 69. A knee rod assembly engages at the tool spindle holding device 1 on both sides, left and right hand side, laterally. The knee rod assembly comprises two connecting rods 601 and 602 which are connected to each other at the knuckle joint 603. In this variant according to the invention the connecting rod 2 is divided into the two connecting rods 601, 602 and the knuckle joint 603. The connecting rod 601 is supported via the joint 604 on the slide 3 which can be moved on the guide 4. By means of a synchronous rotation of the two joints (see arrows 610) 604, 604′ a corresponding excursion of the knee rod assembly 600 is carried out and thus also a change of the level of the tool spindle holding device 1. Simultaneously it is possible to shift the whole arrangement on the guide 68 (if necessary identical with the guide 4) and thus also to achieve a movement in the space. Instead of the rotation of the joints 604, 604′ the tool spindle holding device can be moved along the guide 69 by means of a ball roller spindle or a linear drive. The connecting rods 601 and 602 then have the function to stabilise the tool headstock laterally and in the plane of the drawing in order to reduce the mass of the accompanying guides 69 considerably.

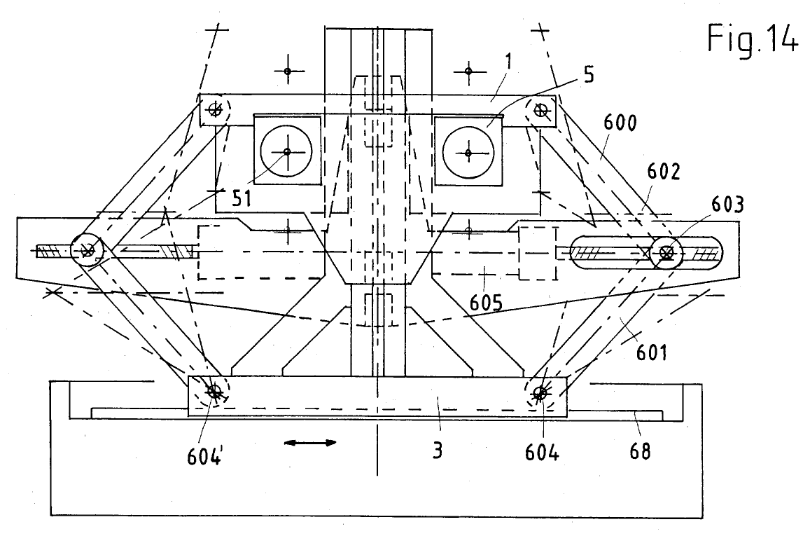

Basing on this idea FIG. 14 shows another variant. Again a knee rod assembly 600 is provided, however, in the joint 603 a tension means 605 engages which can attract, respectively repel, the joint 603. This changes the expansion angle between the two rods 601, 602 and thus also the level of the tool spindle holding device 1 changes. This variant provides that the distance of the joints 604, 604′ is constant, the tension means 605 is arranged on both sides. For a positioning in the XY-plane it is provided that the slide 3 can move on the guide way 68.

Furthermore the invention deals with a machine where at least two main spindles are provided which can be driven along the Z-axis in at least one sleeve. The sleeve(s) is/are guided in a common headstock. X- and Y-axis are formed by at least two or three connecting rods. At least on of these connecting rods is a torsion-proof box. On the right and left hand side of the headstock a vertical stay each is arranged which carries two linear guides each and at least on drive for at least one slide. One of these stays carries the base points of at least two connecting rods, which are supported in such a way that they can be shifted vertically, the other stay of at least one connecting rod.

In another variant of the invention it is provided that for each side of the headstock connecting rods of the same length are provided. Different lengths of the connecting rods may so be provided on the left and right hand side.

It is also provided that the base points of all connecting rods of each side of the headstock are supported by the same slide and that the bearing points are selected in such a way that a parallelogram results.

Furthermore it is provided that in all positions of the axes in all connecting rods the base point on the side of the stay is not below the level of the one on the side of the headstock. This avoids that pockets form where coolants and so on may be collected.

It is provided that the stays are connected to each other on the bottom by means of the machine bed and on the top by means of a cross head or a beam. In a preferred embodiment of the invention it is provided that the tool magazine takes over the function of the cross head. Alternatively it is provided that the stays without the cross head carry at least a tool magazine.

As a device for changing the tools in particular a planar portal robot is used which has a double gripper per spindle. The tools are supplied in the planar magazine in the back of the machine.

In a preferred embodiment of the invention it is provided that at least parts of the stand, namely bed, stay, cross head, slide, connecting rod, headstock, sleeves and so on are each single or together cross flown by a liquid in order to cool them.

It is furthermore advantageous if the rods, respectively the connecting rods, are made of material which is constant in its size, preferably fiber reinforced or carbon fiber reinforced synthetic material.

For a highly exact drive it is provided that the drive of the slide stands is designed as linear motors.

Furthermore it is advantageous that actuating drives are provided in the tool spindle holding device by means of which the positions and/or adjustment of at least one sleeve can be changed. For example a shift in horizontal or vertical direction is provided, or a tipping around the X- or Y-axis.

It is also an advantage that within or behind each stay a counterweight for the vertically driving masses is arranged.

Although the invention has been described by means of exact embodiments which are shown in detail as far as possible, it is pointed out that this serves for illustration purposes only and that the invention is not necessarily restricted to it, because alternative embodiments and methods become clear for experts with regard to the disclosure. Accordingly changes are taken into consideration which can be made without deviation from the content of the described invention.

1. Machine tool with a tool spindle holding device which is connected with at least one rod with a slide stand, and the slide stand can move on a guide, and is through the positioning of the slide stand, accompanied by a positioning of the tool spindle holding device, wherein the tool spindle holding device carries at least two tool spindles.

2. Machine tool according to claim 1, characterised in that a joint (21) is provided between the rod (2) and the tool spindle holding device (1), and the rod (2) is connected flexibly with the tool spindle holding device (1).

3. Machine tool according to claim 1, characterised in that a joint (23) is provided between the rod (2) and the slide stand (3).

4. Machine tool according to claim 1, characterised in that between the guide (4) and the stand (6) of the machine tool a joint (230) is provided.

5. Machine tool according to claim 1, characterised in that the rod (2) is designed like a connecting rod (20), respectively slab-like.

6. Machine tool according to claim 1, characterised in that the rod (2), respectively the connecting rod (20), is made of synthetic material which is fiber reinforced, respectively carbon fiber reinforced.

7. Machine tool according to claim 1, characterised in that at least two rods (2), respectively connecting rods (20), support the tool spindle holding device (1) on one guide (4) each.

8. Machine tool according to claim 1 characterised by a variable length of the rod, respectively connecting rod.

9. Machine tool according to claim 1, characterized in that at least one slide stand (3) is provided on at least one guide (4) of the machine tool and each slide stand (3) holds at least one rod (2) or one connecting rod (20) flexibly.

10. Machine tool according to claim 1, characterised in that the tool spindle holding device (1) is supported per guide (4) over two rods (2), respectively connecting rods (20), and each rod (2), respectively each connecting rod (20), is carried each over its own slide stand (3) on the guide (4).

11. Machine tool according to claim 1, characterised in that the slide stands (3) move each in a different way on a common guide (4), in particular for adjustments of measurement or clearance.

12. Machine tool according to claim 1, characterised in that the machine tool has two, three or four guides (4), and the tool spindle holding device (1) is arranged between the guides (4).

13. Machine tool according to claim 1, characterised in that the tool spindle holding device (1) is supported by the guide (4) via two rods (2), respectively connecting rods (20), in particular parallelogram-like.

14. Machine tool according to claim 1, characterised in that the tool spindle holding device (1) is supported via three connecting rods (20), respectively rods (2), on two guides (4).

15. Machine tool according to claim 1, characterised in that the rods (2), respectively the connecting rods (20), cross.

16. Machine tool according to claim 1, characterised in that a first connecting rod (20), respectively a first rod (2), is supported by a second connecting rod, in particular flexibly.

17. Machine tool according to claim 1, characterised in that the rod (2), respectively the connecting rod (20), is divided by means of a knuckle joint (603) into two sections (601, 602).

18. Machine tool according to claim 1, characterised in that a traction, respectively regulation mechanism (605), acts on the knuckle joint (603).

19. Machine tool according to claim 1, characterised in that the rods, respectively the connecting rods, have the same length.

20. Machine tool according to claim 1, characterised in that the joints (21) of the two rods (2) or connecting rods (20) are arranged in the direction of the guide (4) one behind the other, in particular on a line parallel to the guide on the tool spindle holding device (1).

21. Machine tool according to claim 1, characterised in that the hinge joints (21) at the headstock of the two rods (2), respectively connecting rods (20), which are supported by a guide (4), are arranged on a line which cuts the guide (4) in an acute angle.

22. Machine tool according to claim 1, characterised in that at least on one of the joints (21) of the headstock (1) at least two connecting rods (20), respectively rods (2), are connected.

23. Machine tool according to claim 1, characterized in that two connecting rods (20), respectively rods (2), are connected rigid angled to a common joint (21) of the tool spindle holding device (1).

24. Machine tool according to claim 1, characterized in that at the stand (6) of the machine tool a joint (230) is provided where a guide (4) is supported flexibly and the front end of the rod (2), respectively the connecting rod (20), serves as slide stand.

25. Machine tool according to claim 1, characterized in that the distance (b) of the joints (21, 21′) between two connecting rods (20), respectively rods (2), on the tool spindle holding device (1) is the same as the distance (a) of the joints (23, 23′) on the respective slide stand (3).

26. Machine tool according to claim 1, characterized in that the distance (b) of the joints (21, 21′) between two connecting rods (20), respectively rods (2), on the tool spindle holding device (1) is not the same as the distance (a) of the joints (23, 23′) on the respective slide stand (3).

27. Machine tool according to claim 1, characterized in that the axes of rotation of the n joints on the tool spindle holding device (1) result in an equilateral n-polygon.

28. Machine tool according to claim 1, characterized by a rotation drive of the rod (2), respectively the connecting rod (20), for a rotation around the joint (21, 23).

29. Machine tool according to claim 1, characterized in that a drive, in particular a spindle drive, a ball roller spindle drive or a linear drive, is provided on the guide (4) for the slide stand (3).

30. Machine tool according to claim 1, characterized in that the guide (4) is orientated essentially parallel to the axis (51) of the spindle.

31. Machine tool according to claim 1, characterised in that the guide (4) is orientated essentially rectangularly to the axis (51) of the spindle.

32. Machine tool according to claim 1, characterized in that the guide (4) is orientated vertically.

33. Machine tool according to claim 1, characterized in that the guide (4) is orientated horizontally.

34. Machine tool according to claim 1, characterised in that the slide stand (30) is L-shaped.

35. Machine tool according to claim 1, characterised in that each slide stand (3) has its own guide (4).

36. Machine tool according to claim 1, characterized in that one guide (4) guides several or all slide stands (3).

37. Machine tool according to claim 1, characterized in that the guide (4) itself has a slide-like design and can be positioned on a guide way.

38. Machine tool according to claim 1 characterized in that the tool spindle holding device (1) is designed as headstock (10) or carries a headstock (10), and the headstock (10) holds the tool spindle (5) or the tool spindle holding device (1) carries the tool spindles in a suspended way.

39. Machine tool according to claim 1, characterized by a tool spindle holding device (1), respectively a headstock (10), made of aluminium.

40. Machine tool according to claim 1, characterized in that the tool spindle (5), respectively the headstock (10), can be twisted with reference to the tool spindle holding device (1).

41. Machine tool according to claim 1, characterized in that the tool spindle can be moved and also positioned on the tool spindle holding device in the direction (51) of the spindle axis as well as rectangularly to it.

42. Machine tool according to claim 1, characterized in that on the tools spindle holding device (1) a guide (25) for the rod (2), respectively for the connecting rod (20), is provided.

43. Machine tool according to claim 1, characterized in that a tool magazine is provided in the region of the tool spindle, respectively above the tool spindle.

44. Machine tool according to claim 1, characterised in that for each tool spindle (1) its own tool magazine, for example a disc magazine, is provided.

45. Machine tool according to claim 1, characterized in that a counterweight which is, if necessary, carried flexibly on the tool spindle holding device is provided.

46. Machine tool according to claim 1, characterized in that a counterweight also carried, if necessary flexibly, is provided on the slide stand.
